(19) United States
(12) Patent Application Publication
(10) Pub. No.: US 2015/0261400 A1
(43) Pub. Date: Sep. 17, 2015

(54) SYSTEM AND METHOD FOR GENERATING A PROCESS FLOW STRUCTURE

(71) Applicant: YOKOGAWA ELECTRIC CORPORATION, Tokyo (JP)

(72) Inventor: Deepa Prabhu Karkala Pulkeri, Bangalore (IN)

(73) Assignee: YOKOGAWA ELECTRIC CORPORATION, Tokyo (JP)

(21) Appl. No.: 14/455,141

(22) Filed: Aug. 8, 2014

(30) Foreign Application Priority Data
Mar. 12, 2014 (IN) 1280/CHE/2014

(51) Int. Cl. G06F 3/0484; G06F 3/0481

(52) U.S. Cl. CPC G06F 3/0484; G06F 3/0481

(57) ABSTRACT

The invention relates to apparatuses, methods and programs for identification and presentation of suggested process flow structures on a display device, as selectable options for addition to a partially generated process flow structure. The system of the invention comprises a graphical environment controller, a comparison engine, and optionally any one or more of a display controller, a structure-record convertor, a record-structure convertor, a repository, and a display device. The invention receives a first user input identifying a node within a first process flow structure. A second process flow structure is retrieved from among previously stored process flow structures, based on identifying a predefined degree of similarity between the first process flow structure and the second process flow structure. Thereafter, a selectable process flow structure is displayed for addition to the first process flow structure, which selectable process flow structure comprising a subset of the second process flow structure.

### TECHNICAL FIELD

The invention concerns generating, graphically rendering, or visually displaying process flow structures or process flow diagrams. More particularly, the invention relates to apparatuses, methods and programs for identification and presentation of suggested process flow structures on a display device, as selectable options for addition to a partially generated process flow structure or process flow diagram.

### BACKGROUND

Process flow diagrams comprise graphical representations of an algorithm or process, wherein process steps are represented as nodes of various types and the order of execution of process steps is specified by interconnections (preferably directed interconnections such as arrows) between the nodes.

A process flow diagram may be understood to include (i) a process flow structure, comprising an ordered arrangement of nodes, and (ii) process steps for execution at each node of the process flow structure. FIG. 1A illustrates an exemplary process flow structure 100a comprising an ordered arrangement of nodes 101a to 105a. FIG. 1B illustrates a process flow diagram 100b based on the process flow structure of FIG. 1A, wherein process steps have been defined for each of nodes 101b to 105b. The process flow diagram of FIG. 1B represents an exemplary process for addition of two numbers.

Process flow diagrams may be created in a processor implemented editor environment, wherein a process flow diagram may be defined and graphically rendered or displayed on a visual display device, based on user input. User inputs that define a process flow diagram specify:
(i) the process flow structure—which process flow structure may be specified by identifying the number and type of nodes within the process flow, position of each node, and interconnections between nodes; and
(ii) process step(s) for execution at each node.

Creation of process flow diagrams is accordingly time and effort intensive. Additionally, different processes may often be represented using identical, similar or partially similar process flow structures—with differences manifested in the specific process steps executed at nodes within the process flow structure. By way of example, FIG. 1C illustrates a process flow diagram 100c consisting of nodes 101c to 105c and having a process flow structure identical to the process flow structure of FIG. 1A. It would be observed that despite the number of nodes, node types and node interconnections being identical in FIGS. 1A and 1B, the process steps executed at nodes 102c to 104c are entirely different from those executed at nodes 102b to 104b of FIG. 1B.

Similarities between process flow structures also arises as a consequence of re-use of standardized sub-processes or sub-routines in each process.

Consequently, in creating a process flow structure, an operating user may (knowingly or unknowingly) invest significant resources towards duplication of process flow structures that have been previously created.

There is accordingly a need for efficient creation of process flow structures, and for avoiding inadvertent duplication of effort towards creation of process flows that have been previously created.

### SUMMARY OF THE INVENTION

The invention comprises a system for generating a process flow structure including a plurality of interconnected nodes, and configured to communicate with a process flow structure storage repository. The system may comprise a processor, a graphical environment controller and a comparison engine. The graphical environment controller may be configured to receive a first user input identifying a node within a first process flow structure. The graphical environment controller may additionally be configured to display on a display device, a selectable process flow structure for addition to the first process flow structure.

The comparison engine may be configured to compare the first process flow structure with previously stored process flow structures within the repository. Based on comparison results, the comparison engine may retrieve from among the previously stored process flow structures, a second process flow structure. Retrieval of the second process flow structure is based on identifying a predefined degree of similarity between the first process flow structure and the second process flow structure. In an embodiment, the selectable process flow structure displayed by the graphical environment controller may comprise a subset of the retrieved second process flow structure.

The comparison engine may be further configured to retrieve a plurality of process flow structures from among the previously stored process flow structures. Retrieval of each process flow structure from the repository is based on identifying a predefined degree of similarity between the first process flow structure and said retrieved process flow structure.

The graphical environment controller may be configured to display a plurality of selectable process flow structures for addition to the first process flow structure, wherein each selectable process flow structure comprises a subset of one of the retrieved plurality of process flow structures.

In an embodiment, the graphical environment controller may be configured to receive a second user input selecting a subset of the displayed selectable process flow structure for addition to the first process flow structure. The graphical environment controller may be configured such that the subset of the displayed selectable process flow structure selected by the second user input comprises the entire displayed selectable process flow structure.

The graphical environment controller may further be configured to display a combined process flow structure. The combined process flow structure may comprise the selected subset of the displayed selectable process flow structure added to the first process flow structure.

In an exemplary embodiment, the graphical environment controller may be configured to add the selected subset of the displayed selectable process flow structure to the first process flow structure, at the node identified by the first user input.

The comparison engine of the system may be configured to identify a predefined degree of similarity between the second process flow structure and the first process flow structure. Identification of a predefined degree of similarity may occur responsive to determining that the second process flow structure includes a second set of nodes and corresponding interconnections that are identical to a first set of nodes and corresponding interconnections within the first process flow structure.

The comparison engine may further be configured such that determining that the second process flow structure includes a second set of nodes and corresponding interconnections that are identical to a first set of nodes and corresponding interconnections within the first process flow structure, comprises comparing node attributes respectively associated with nodes within the first set of nodes and the second set of nodes.

The comparison engine may be configured to compare node attributes including one or more of node symbols, parent nodes, associated child nodes, outgoing connections and incoming connections respectively associated with a corresponding node.

In an embodiment of the system, the comparison engine may be configured such that comparing the first process flow structure with previously stored process flow structures comprises comparing information representing the first process flow structure with information representing each previously stored process flow structure.

In a more particular embodiment, the comparison engine may retrieve (i) information representing the first process flow structure, from a first process flow record corresponding to the first process flow structure and (ii) information representing a previously stored process flow structure, from a second process flow record corresponding to a previously stored process flow structure. The first process flow record and said second process flow record may be generated by a first convertor configured to convert process flow structures to process flow records.

The first convertor may configured to generate process flow records comprising a set of data records, each data record representing a node within the corresponding process flow structure as a collection of associated node attributes. The generated process flow records may further comprise a set of data fields corresponding to each data record, wherein each data field within a data record represents a node attribute associated with the represented node.

The comparison engine may also be configured such that comparing information representing the first process flow structure with information representing a previously stored process flow structure comprises comparing a first set of data records within the first process flow record with a second set of data records within the second process flow record.

In a specific embodiment of the system, the comparison engine may be configured such that comparing data records within the first process flow record with data records within the second process flow record comprises determining whether the second set of data records and the first set of data records have identical data field values.

The system may additionally include a second convertor configured to convert process flow records to process flow structures. Responsive to a determination that the second set of data records and the first set of data records have identical data field values (i) the comparison engine retrieves information corresponding to the second set of data records from the second process flow record, (ii) the second convertor converts the retrieved information to a selectable process flow structure, and (iii) the graphical environment controller graphically displays the selectable process flow structure on the display device.

The invention also comprises a method for generating a process flow structure comprising a plurality of interconnected nodes. The method comprises the steps of (i) receiving a first user input identifying a node within a first process flow structure, (ii) retrieving from among previously stored process flow structures, a second process flow structure, wherein retrieval of the second process flow structure is based on identifying a predefined degree of similarity between the first process flow structure and the second process flow structure, and (iii) displaying a selectable process flow structure for addition to the first process flow structure, the selectable process flow structure comprising a subset of the second process flow structure.

The method step of retrieving may in an embodiment, comprise retrieving a plurality of process flow structures from among the previously stored process flow structures, wherein retrieval of each process flow structure is based on identifying a predefined degree of similarity between the first process flow structure and said retrieved process flow structure. The method step of displaying may comprise displaying a plurality of selectable process flow structures for addition to the first process flow structure, wherein each selectable process flow structure comprises a subset of one of the retrieved plurality of process flow structures.

In one embodiment of the method, the first process flow structure is a partially generated process flow structure. In a further embodiment, a subset of the displayed selectable process flow structure may be selected by a second user input for addition to the first process flow structure. In a yet more particular embodiment, the subset selected by the second user input may comprise the entire displayed selectable process flow structure.

The first process flow structure may be modified by adding the selected subset of the displayed selectable process flow structure. In a specific embodiment, the selected subset of the displayed selectable process flow structure may be added to the first process flow structure at the node identified by the first user input.

In one method embodiment, a predefined degree of similarity between the second process flow structure and the first process flow structure is identified in response to a determination that the second process flow structure includes a second set of nodes and corresponding interconnections that are identical to a first set of nodes and corresponding interconnections within the first process flow structure.

In a more particular method embodiment, determining that the second process flow structure includes a second set of nodes and corresponding interconnections that are identical to a first set of nodes and corresponding interconnections within the first process flow structure, may comprise comparing node attributes respectively associated with nodes within the first set of nodes and the second set of nodes. The node attributes may include one or more of node symbols, parent nodes, associated child nodes, outgoing connections and incoming connections respectively associated with a corresponding node.

In another embodiment of the method, retrieving at least a second process flow structure from among previously stored process flow structures includes comparing information representing the first process flow structure with information representing each previously stored process flow structure. In a more specific embodiment, (i) information representing the first process flow structure may be retrieved from a first process flow record corresponding to the first process flow structure, and (ii) information representing a previously stored process flow structure may be retrieved from a second process flow record corresponding to a previously stored process flow structure.

In an embodiment of the above method, each process flow record may comprise a set of data records, wherein each data record represents a node within the corresponding process flow structure as a collection of associated node attributes. Each process flow record may additionally comprise a set of data fields corresponding to each data record, wherein each data field within a data record represents a node attribute associated with the represented node.

Comparing information representing the first process flow structure with information representing a previously stored process flow structure may, in an embodiment, comprise comparing a first set of data records within the first process flow record with a second set of data records within the second process flow record.

Comparing data records within the first process flow record with data records within the second process flow record may include determining whether the second set of data records and the first set of data records have identical data field values.

The method may include the step of responding to a determination that the second set of data records and the first set of data records have identical data field values, with the steps of (i) retrieving information corresponding to the second set of data records from the second process flow record, and (ii) graphically rendering the selectable process flow structure on a display device, wherein the selectable process flow structure is rendered based on retrieved information corresponding to the second set of data records.

The invention also included a computer program product for generating a process flow structure comprising a plurality of interconnected nodes, the computer program product comprising a non-transitory computer readable medium having computer readable program code embodied therein. The computer readable program code may comprise instructions for (i) receiving a first user input identifying a node within a first process flow structure, (ii) retrieving from among previously stored process flow structures, a second process flow structure, wherein retrieval of the second process flow structure is based on identifying a predefined degree of similarity between the first process flow structure and the second process flow structure, and (iii) displaying a selectable process flow structure for addition to the first process flow structure, the selectable process flow structure comprising a subset of the second process flow structure.

### BRIEF DESCRIPTION OF THE ACCOMPANYING DRAWINGS

FIG. 1A illustrates an exemplary process flow structure.

FIGS. 1B and 1C illustrate process flow diagrams.

FIGS. 2A to 2H provide an illustrative set of standardized node symbols.

FIGS. 3 to 5B, 7, 9A and 10A illustrate embodiments of process flow structures generated or retrieved by the method of the invention.

FIGS. 6, 11, 12, 13 and 14 are flowcharts illustrating method embodiments of the present invention.

FIG. 8 illustrates an embodiment of a data structure template for creating process flow records.

FIGS. 9B and 10B illustrate process flow records respectively representing the process flow structures illustrated in FIGS. 9A and 10A.

FIGS. 15A to 15C illustrate an exemplary editor environment.

FIG. 16 illustrates an exemplary system embodiment of the invention.

FIG. 17 illustrates an exemplary system in which embodiments of the invention may be implemented.

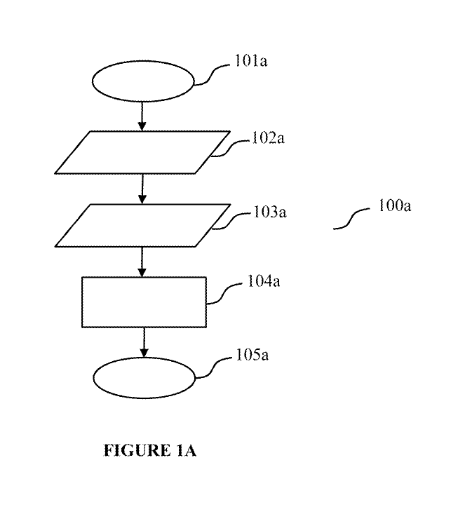

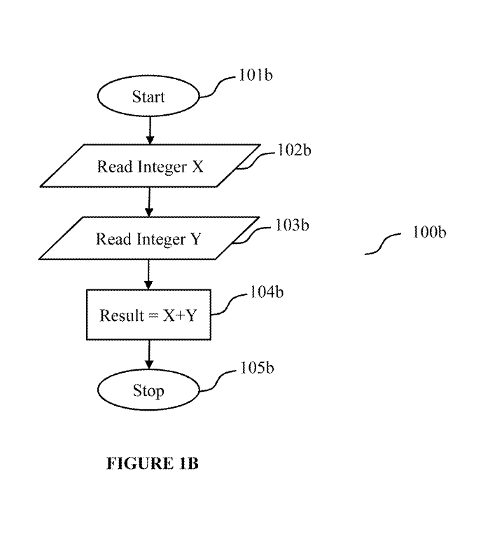

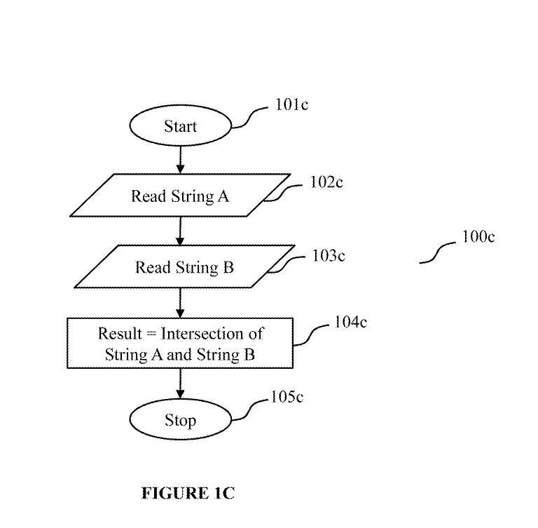

### DETAILED DESCRIPTION

For the purpose of describing the present invention, certain terms are defined below. Except where expressly defined, terms within the specification and claims shall be understood to have the meaning that would be apparent to one of ordinary skill in the art.

“Burst node” refers to a node within a process flow structure or a process flow diagram from which the process flow under execution diverges to multiple nodes. Stated differently, a burst node refers to a node having multiple child nodes.

“Child node” refers to a node directly connected to a node under consideration, such that the process flow passes directly from the node under consideration to the child node.

“Node” refers to a discrete process step within a process flow structure or a process flow diagram. Nodes may be represented using standardized symbols representative of the type of process or operation performed at the node.

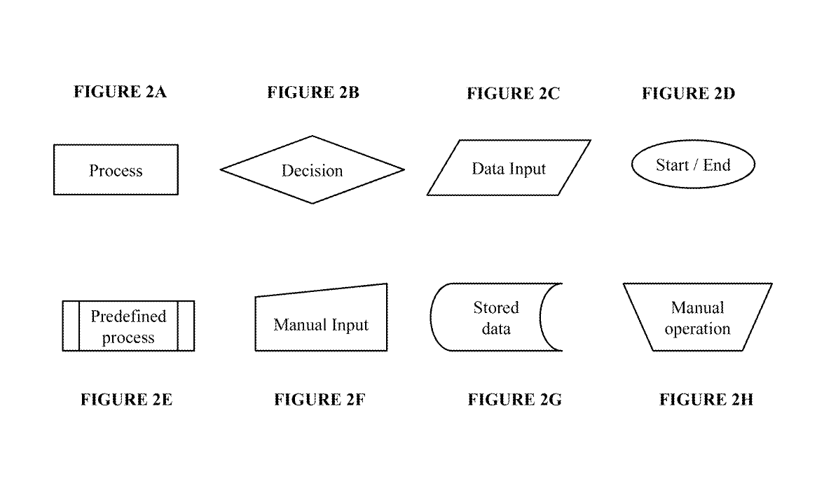

“Node symbol” refers to a symbol uniquely associated with a process step category. In graphically rendering or displaying a process flow structure or a process flow diagram, each node may be represented by a node symbol, wherein the selected node symbol is uniquely associated with a process step category applicable to that node. FIGS. 2A to 2H provide an illustrative set of standardized node symbols used in creating a process flow structure or process flow diagram, and respectively illustrate a process node, decision node, data input node, start/end node, predefined process node, manual input node, stored data node, and manual operation node.

“Parent node” refers to a node directly connected to a node under consideration, such that the process flow passes directly from the parent node to the node under consideration.

“Process flow diagram(s)” refers to a graphical representation of an algorithm or process, wherein process steps are illustrated within nodes and the order of execution of process steps is specified by interconnections (such as arrows or other connection lines) between nodes. Without limitation to the generality of the above, process flow diagram(s) include flow charts (including process flowcharts and functional flowcharts), process charts (including process maps and functional process charts), process models (including business process models) and flow diagrams (including process flow diagrams, work flow diagrams and business flow diagrams).

“Process flow record” refers to a data record comprising information representative of attributes of a process flow structure, which information may be used to graphically render or display a process flow structure on a display device.

“Process flow structure” refers to a graphical representation of an ordered arrangement of nodes and interconnections between said nodes. Process flow structures are a function of one or more of the number and types of nodes selected for inclusion, positioning of nodes, and interconnections between nodes.

“Process step category” refers to a predefined categorization applicable to process steps within a process flow structure or a process flow diagram. Examples of process step categories include processing steps, decisions steps, data input/output steps, start/end steps, predefined processing steps, manual input steps and manual operation steps.

“Repository” refers to a database or other computer readable storage medium that is configurable to store process flow structures.

“Sibling node” refers to a node which shares a parent node with a node under consideration.

“Sink Node” refers to a node within a process flow structure or a process flow diagram at which the process flow converges from multiple nodes. Stated differently, a sink node refers to a node having multiple parent nodes.

The invention enables creation of process flow structures or process flow diagrams based on predictively generated process flow structures. The invention achieves this by displaying to a user, one or more suggested process flow structures for completing a partially generated process flow structure. The invention enables the user to browse or otherwise review one or more suggested process flow structures, and to select part or whole of a suggested process flow structure for adding to the partially generated process flow structure. The invention selects and retrieves suggested process flow structures or parts thereof, for display to a user, from a database of previously stored process flow structures. Selection and retrieval may be based on a plurality of factors, including determining that the one or more suggested process flow structures have a predefined degree of similarity with the partially generated process flow structure.

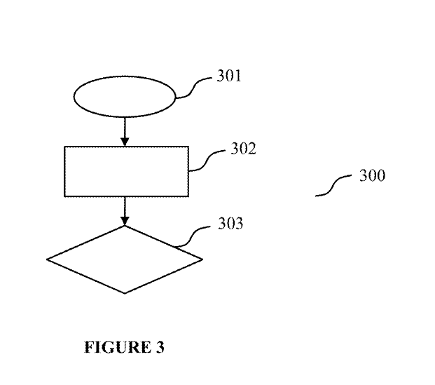

FIGS. 3 to 5B illustrate an implementation of the invention.

FIG. 3 illustrates a partially generated process flow structure 300 created by a user in a processor implemented editor environment. The partially generated flow structure comprises nodes 301 to 303 with interconnections therebetween. Nodes 301, 302 and 303 respectively comprise standardized node symbols representative of a start node, a process node and a decision node. It would be understood that process flow structures based on user inputs may be generated in any one of several ways using a processor implemented editor environment. For example, the editor environment may provide drawing tools, and/or selectable templatized node symbols and interconnection symbols which enable an operating user to create a process flow structure for display and/or storage.

Responsive to creation of the partially generated process flow structure 300, the invention searches through a repository of previously stored process flow structures, and selects and retrieves one or more partial or complete process flow structures having an arrangement of nodes and interconnections that are (i) identical to or (ii) have a predefined degree of similarity with, the arrangement and interconnection of nodes in partially generated process flow structure 300. Systems and methods for enabling search, selection and retrieval for similar or identical process flow structures from a database of previously stored process flow structures are discussed subsequently in this document.

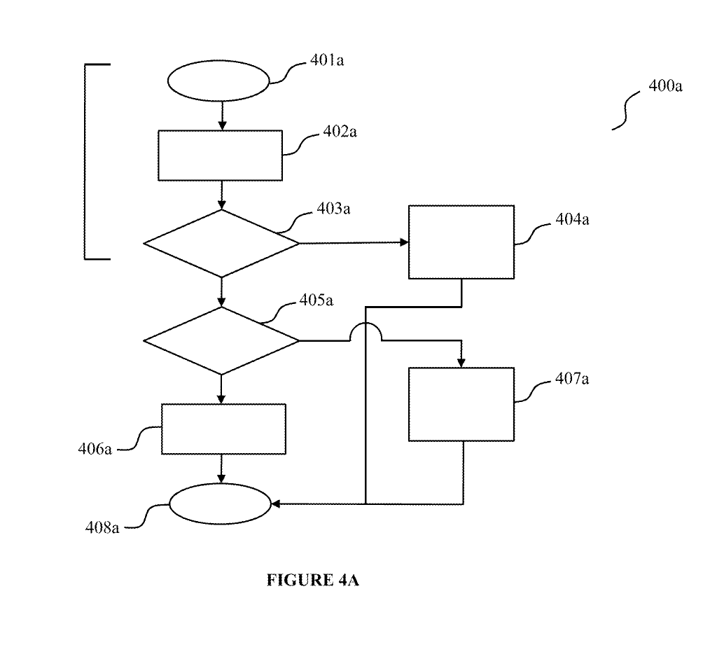

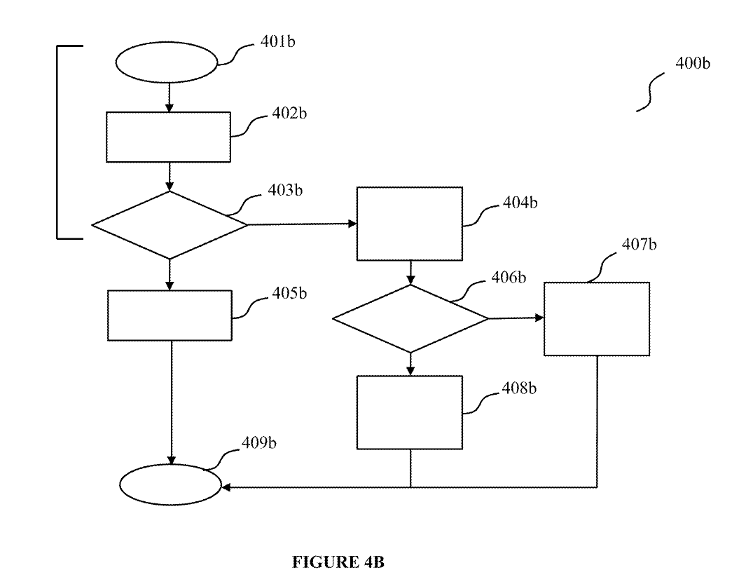

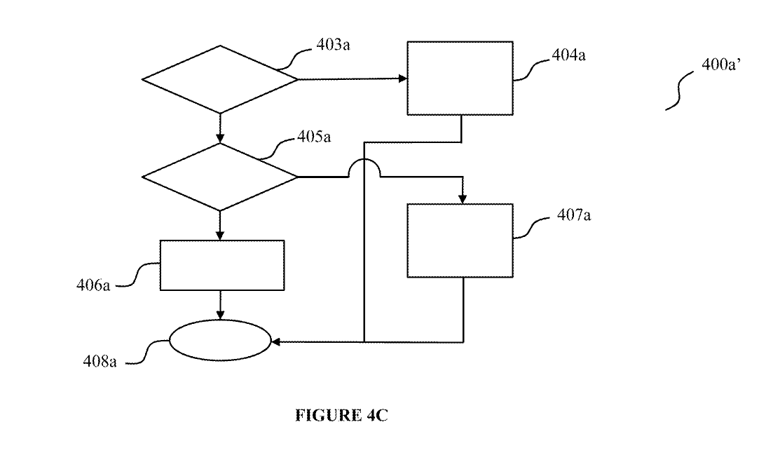

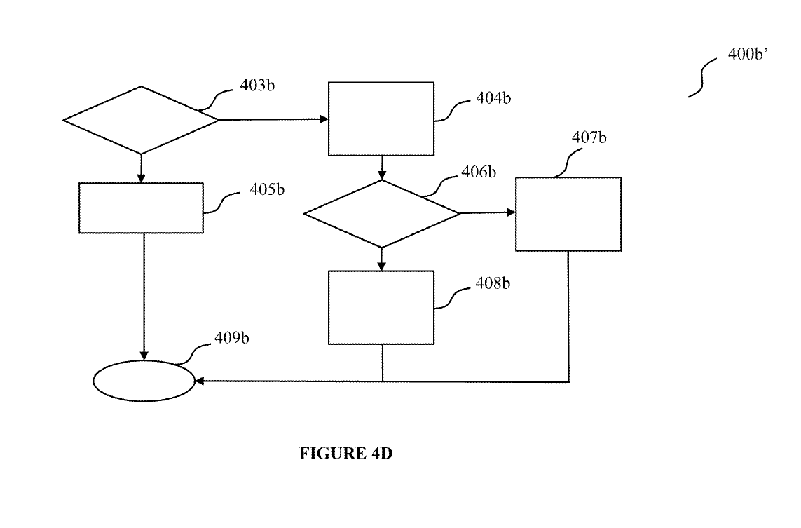

FIGS. 4A and 4B provide illustrative examples of two different process flow structures 400a and 400b each having a sub-set of nodes and interconnections identical to the arrangement of nodes 301 to 303 (in FIG. 3), and which process flow structures are therefore suitable for selection from a repository containing previously stored process flow structures. Specifically, while process flow structure 400a (FIG. 4A) comprises an arrangement of interconnected nodes 401a to 408a, the specific arrangement and interconnection of sub-set of nodes 401a to 403a is identical to the arrangement and interconnection of nodes 301 to 303 of partially generated process flow structure 300. Similarly, while process flow structure 400b (FIG. 4B) comprises an arrangement of interconnected nodes 401b to 409b, the specific arrangement and interconnection of nodes 401b to 403b is identical to the arrangement and interconnection of nodes 301 to 303 of partially generated process flow structure 300.

Process flow structures 400a and 400b (or the relevant identical subsets of said process flow structures) may be displayed to a user in the form of suggested options for completing partially generated process flow structure 300. FIGS. 4C and 4D illustrate an embodiment of the invention wherein subsets 400a′ and 400b′ of process flow structures 400a and 400b respectively, may be presented to the user in the form of suggested alternative options for completing partially generated process flow structure 300.

FIG. 4C illustrates subset 400a′ of process flow structure 400a which may be displayed to a user as a first suggested option for completing partially generated process flow structure 300. Subset 400a′ comprises nodes 403a to 408a that may be presented to the user as a suggested option for completing partially generated process flow structure 300. It will be noted that in the illustrated embodiment, subset 400a′ omits nodes 401a and 402a (illustrated in FIG. 4A) and commences the illustrated sub-set at node 403a.

Similarly, FIG. 4D illustrates a subset 400b′ of process flow structure 400b which may be displayed to a user as a second suggested option for completing partially generated process flow structure 300. Subset 400b′ comprises nodes 403b to 409b that may be presented to the user as a suggested option for completing partially generated process flow structure 300.

By commencing display of the suggested first and second suggested options at nodes 403a and 403b respectively (i.e. by omitting nodes 401a and 402a of FIG. 4A, or nodes 401b and 402b of FIG. 4B respectively), the user is presented with parts of process flow structures 400a and 400b that are most appropriate for being added to the last node 303 of partially generated flow structure 300. It would be understood that the invention may also be practiced by displaying the entire process flow structures of FIGS. 4A and 4B to the user. However, the abbreviated FIGS. 4C and 4D presents information that is most relevant to the user's decision regarding nodes and interconnections that require to be added to node 303.

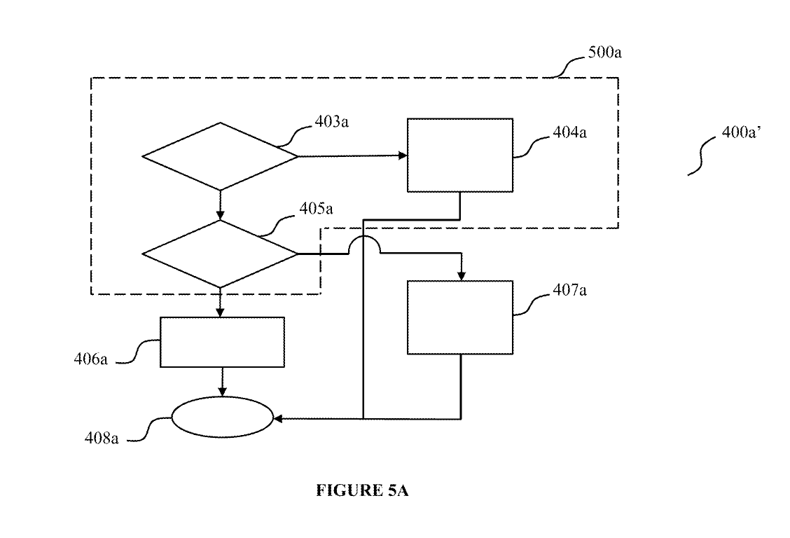

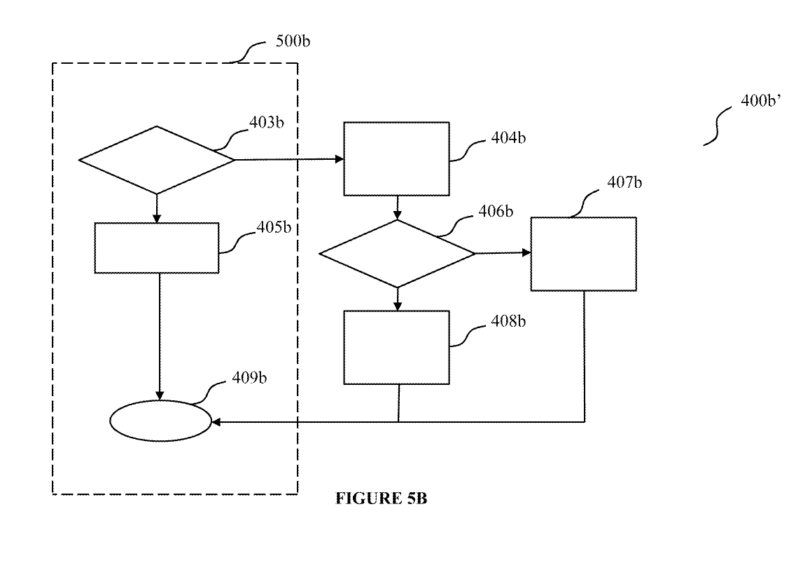

Based on the suggested process flow structures, a user may select either an entire suggested flow structure, or a part thereof for addition to a partially generated process flow structure. For example, when presented with the first and second options illustrated in FIGS. 4C and 4D, the user may choose to implement (at node 303 of FIG. 3) the entire flow structure presented in either the first option or the second option. Alternatively, as illustrated in FIG. 5A, the user may highlight or otherwise select a sub-structure (such as sub-structure 500a comprising nodes 403a, 404a and 405a and interconnections therebetween) from process flow structure 400a′ for implementation or inclusion at node 303 of FIG. 3. Similarly, as shown in FIG. 5B the user may highlight or otherwise select a sub-structure (such as sub-structure 500b comprising nodes 403b, 405b and 409b and interconnections therebetween) from process flow structure 400b′ for inclusion at node 303 of FIG. 3. In an embodiment of the invention, selected sub-structure 500a or 500b may simply replace node 303 of the partially generated process flow structure 300 illustrated in FIG. 3.

It would be understood that highlighting or selecting a sub-structure within a larger process flow structure (such as has been illustrated in FIGS. 5A and 5B) may be achieved by a number of standard tools available within an editor environment and which permit for selection of one or more nodes and/or one or more interconnections. Exemplary tools may include selection tools, snaphshot tools or grouping tools.

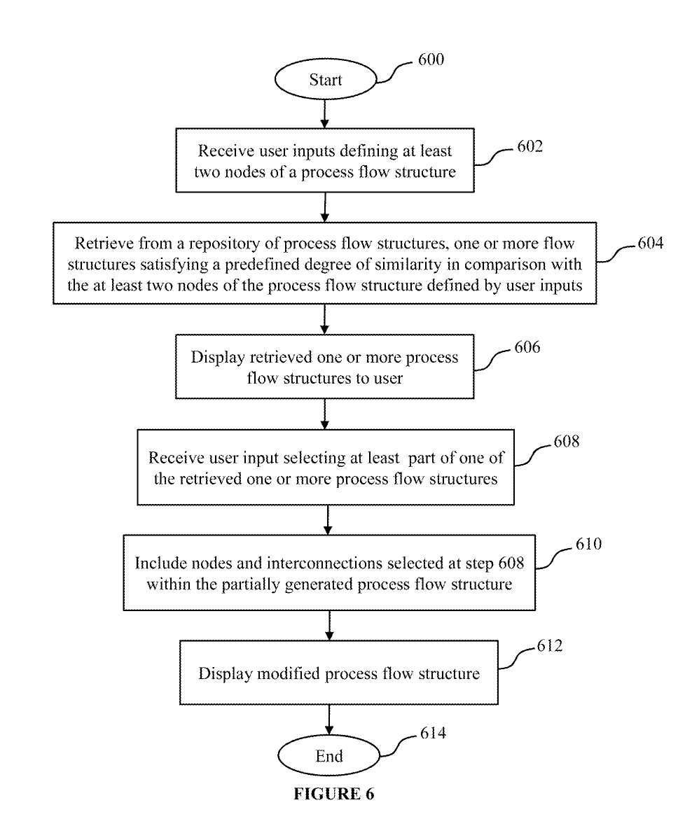

FIG. 6 an embodiment of the above method. At step 602 user inputs are received, which user inputs define a partial process flow structure. The partial process flow structure defined by the received user inputs may comprise at least two interconnected nodes. At step 604, the method selects from a repository of process flow structures, one or more previously created flow structures satisfying a predefined degree of similarity in comparison with the at least two interconnected nodes of the partially generated process flow structure.

The selected one or more process flow structures or a part thereof, may be displayed to the user at step 606 as potential or suggested additions to the partially generated process flow structure. At step 608, user input is received, selecting at least part of one of the displayed one or more process flow structures. Step 610 adds to the partially generated process flow structure, nodes and interconnections selected by the user at step 608. The modified process flow structure is displayed at step 612.

It would be understood that the present invention may implement any appropriate method or apparatus to enable (i) search through a database of previously stored process flow structures, and (ii) selection and retrieval of process flow structures having an arrangement of nodes and interconnections that are identical (or similar to a predefined degree) to the arrangement and interconnection of nodes in the partially generated process flow structure.

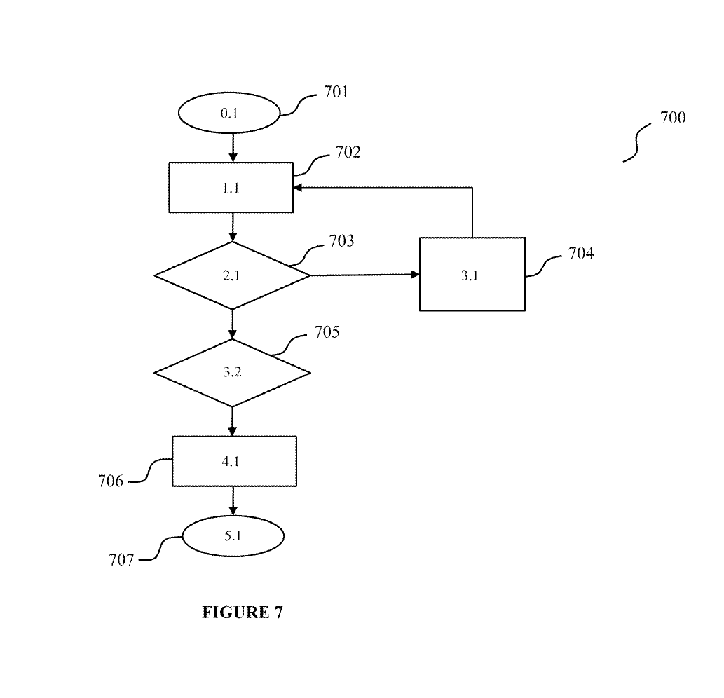

Embodiments of such methods are described below with reference to FIGS. 7 to 14, which methods rely on representing and storing a process flow structure as a process flow record comprising information regarding attributes of. The method includes:
representing each node within a process flow structure as a collection of node attributes, and
storing node attributes for individual nodes of a process flow structure within a process flow record corresponding to said process flow structure.

Individual nodes of a process flow structure may be represented as a collection of node attributes (i.e. node properties), which may include one or more of a Node ID, a Node Type ID, Inward Connection Point ID, Outward Connection Point ID, Parent ID and Child ID. Each of these node attributes are explained below.

Node ID—The Node ID is an identifier uniquely associated with a specific node within a process flow structure. Node IDs may be generated and assigned in accordance with any methodology, provided each node has an unique Node ID associated with it.

FIG. 7 illustrates an exemplary embodiment of the invention wherein the Node IDs are selected such that each Node ID represents a hierarchical position of the corresponding node within a process flow structure. As illustrated in FIG. 7, process flow structure 700 comprises nodes 701 to 707. Each node within process flow structure 700 is represented with a unique Node ID having the following general expression:

(x)·(y+1) Expression (I)
wherein X is a counter representing a minimum number of nodes, commencing from the start node, which require to be traversed for control flow to reach the node under consideration; and
wherein Y is a counter representing the number of sibling nodes that have been generated from the parent node (of the node under consideration) prior to generation of the node under consideration.

Applying expression (I) to the nodes represented in FIG. 7, corresponding Node IDs may be generated in the following manner:
Node 701
   Since node 701 is a start node, there are 0 nodes which require to be traversed for control flow to reach said node. The value of X is therefore 0.
   Since node 701 does not have sibling nodes already generated from its parent node, the value of Y is 0.
   The Node ID corresponding to node 701 is accordingly (X)·(Y+1) i.e. 0.1
Node 702
   There is 1 node (node 701) which requires to be traversed for control flow to reach node 702. The value of X is therefore 1.
   Since node 702 does not have sibling nodes already generated from its parent node (node 701), the value of Y is 0.
   The Node ID corresponding to node 702 is accordingly (X)·(Y+1) i.e. 1.1
Node 703
   There are 2 nodes (nodes 701 and 702) which require to be traversed for control flow to reach node 703. The value of X is therefore 2.
   Since node 703 does not have sibling nodes already generated from its parent node (node 702), the value of Y is 0.
   The Node ID corresponding to node 702 is accordingly (X)·(Y+1) i.e. 2.1
Node 704
   There are 3 nodes (nodes 701, 702 and 703) which require to be traversed for control flow to reach node 704. The value of X is therefore 3.
   Since node 704 does not have sibling nodes already generated from its parent node (node 703), the value of Y is 0.
   The Node ID corresponding to node 702 is accordingly (X)·(Y+1) i.e. 3.1
Node 705
   There are 3 nodes (nodes 701, 702 and 703) which require to be traversed for control flow to reach node 705. The value of X is therefore 3.
   Since node 705 has one sibling node (node 704) already generated from its parent node (node 703), the value of Y is 1.
   The Node ID corresponding to node 705 is accordingly (X)·(Y+1) i.e. 3.2
Node 706
   There are 4 nodes (nodes 701, 702, 703 and 704) which require to be traversed for control flow to reach node 706. The value of X is therefore 4.
   Since node 706 does not have any sibling nodes already generated from its parent node (node 703), the value of Y is 0.
   The Node ID corresponding to node 705 is accordingly (X)·(Y+1) i.e. 4.1
Node 707
   There are 5 nodes (nodes 701, 702, 703, 704 and 705) which require to be traversed for control flow to reach node 707. The value of X is therefore 5.
   Since node 707 does not have any sibling nodes already generated from its parent node (node 706), the value of Y is 0.
   The Node ID corresponding to node 705 is accordingly (X)·(Y+1) i.e. 5.1

Node Type ID—The Node Type ID is an identifier uniquely associated with the node symbol (and corresponding process step category represented by said node symbol) used to represent a specific node. Table A below presents an exemplary set of associations between Node Type IDs and respective node types or node symbols that may identify respective node types.

TABLE A

| Node Type/Node Symbol | Node Type ID |
|---|---|
| Start/End | 0 |
| Process | 1 |
| Decision | 2 |
| Data Input | 3 |
| Predefined Process | 4 |
| Manual Input | 5 |
| Stored Data | 6 |
| Manual Operation | 7 |

While the Node Type IDs in Table A are simple numeric identifiers, it would be understood that Node Type IDs may comprise any other set of identifiers that are capable of uniquely identifying each node type or node symbol within a process flow structure.

Inward Connection Point ID—The Inward Connection Point ID defines a localized position at the perimeter of a node under consideration at which an incoming interconnection from another node interfaces with the node under consideration. In an embodiment, the Inward Connection Point ID may comprise a numerical value uniquely associated with a corresponding position at the perimeter of a node at which an incoming interconnection interfaces with the node under consideration.

Outward Connection Point ID—The Outward Connection Point ID defines a localized position at the perimeter of a node under consideration at which an outgoing interconnection (to another node) interfaces with the node under consideration. In an embodiment, the Outward Connection Point ID may comprise a numerical value uniquely associated with a corresponding position at the perimeter of a node at which an outgoing interconnection interfaces with the node under consideration.

In an embodiment of the invention, each node within a process flow structure may have four localized positions at the perimeter configured for interfacing with incoming or outgoing interconnections with other nodes. In one embodiment, these localized positions may be located at the top, right, bottom and left sides of the node perimeter. In a preferred embodiment, each of these top, right, bottom and left localized positions may be represented by corresponding numerical values uniquely associated with the corresponding position on the node perimeters, any of which values may serve as an Inward Connection Point ID or an Outward Connection Point ID of a node under consideration.

Table B presents an exemplary embodiment of numerical values which may be used to define localized positions at node perimeters that interface with incoming or outgoing interconnections with other nodes.

TABLE B

| Localized Interface Position at Node | |
|---|---|
| Perimeter | ID Value |
| Top | 0 |
| Right | 1 |
| Bottom | 2 |
| Left | 3 |

Taking for example, node 706 of FIG. 7, based on the ID values provided in Table B, said node has an Inward Connection Point ID value of 0 (signifying an incoming connection at the top side of the node perimeter) and an Outward Connection Point ID value of 2 (signifying an outgoing connection at the bottom side of the node perimeter). On the other hand, node 702, has two incoming connections respectively at the top side and right side of said node—and accordingly would have two Inward Connection Point ID values of 0 and 1 respectively. Node 702 has only a single outgoing connection, at the bottom side of said node—and would therefore have a single Outward Connection Point ID value of 2.

Parent ID—The Parent ID is a node attribute comprising information identifying a parent node from which the node under consideration is derived. It would be understood that in case of a sink node, the Parent ID node attribute may identify multiple parent nodes which converge at the sink node. In an embodiment of the invention the Parent ID may identify a parent node by using the unique Node ID corresponding to such parent node.

Child ID—the Child ID is a node attribute comprising information identifying a child node derived from the node under consideration. It would be understood that in case of a burst node, the Child ID node attribute may identify multiple child nodes diverging from the burst node. In an embodiment of the invention, the Child ID may identify a child node by using the unique Node ID corresponding to such child node.

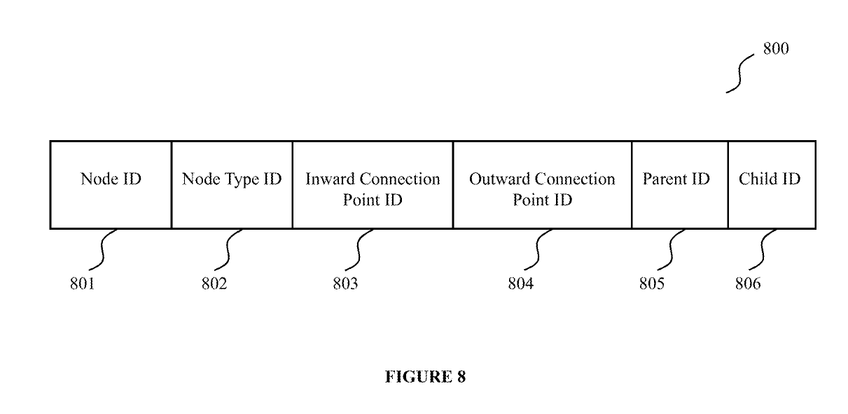

FIG. 8 illustrates an embodiment of a data structure template 800 which may form the basis for creating a process flow record for recording a process flow structures. Data structure 800 includes data fields 801 to 806 for recording Node ID (801), Node Type ID (802), Inward Connection Point ID (803), Outward Connection Point ID (804), Parent ID (805) and Child ID (806) corresponding to each node within a represented flow structure.

While FIG. 8 illustrates an exemplary data structure template, it would be understood that process flow records may be created within any data structure capable of recording information representing process flow structures, including tables, matrices, spreadsheets, two dimensional arrays, xml document or appropriately configured database schemas.

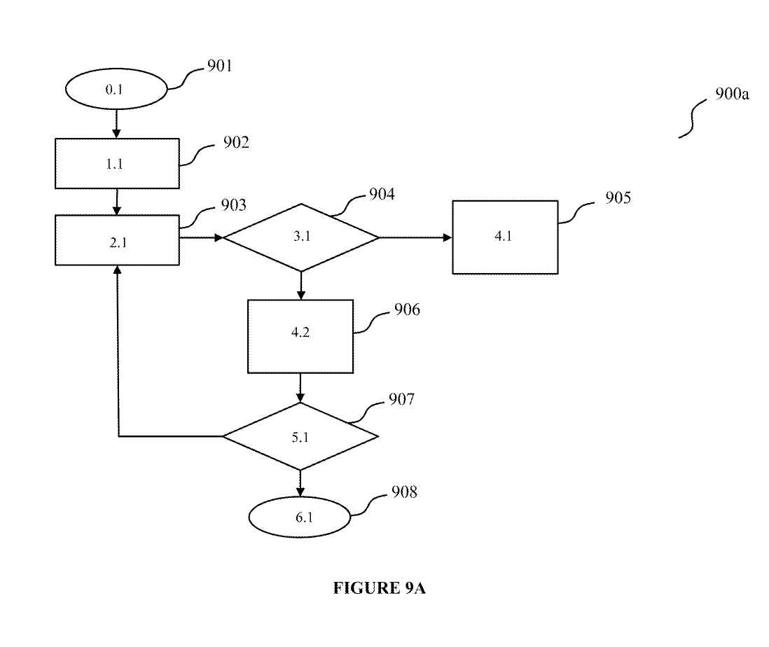

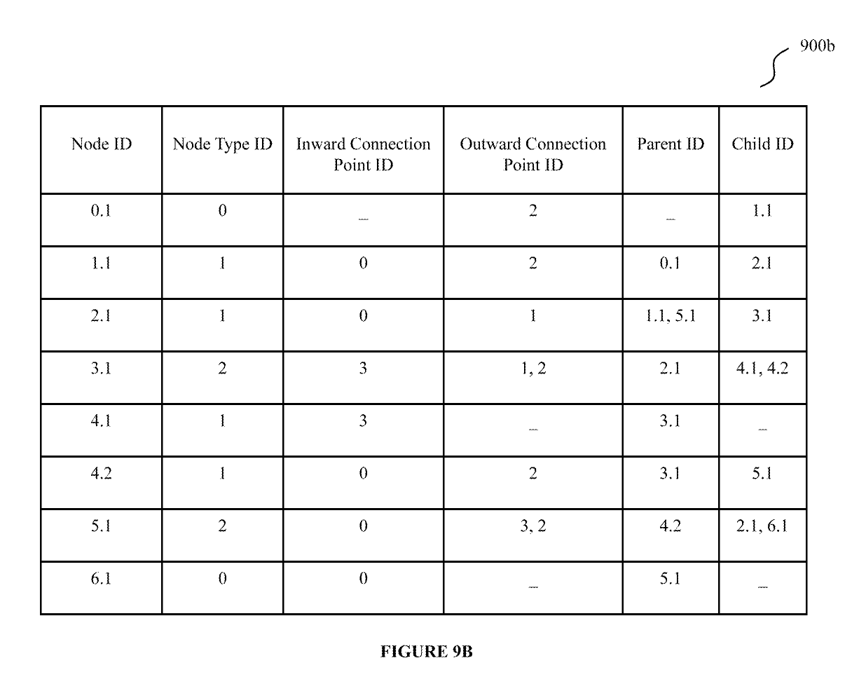

FIG. 9A provides an exemplary process flow structure 900a comprising nodes 901 to 908. FIG. 9B illustrates a corresponding process flow record 900b (which is based on the data structure illustrated in FIG. 8) generated to represent process flow structure 900a. It will be noted that in this exemplary embodiment, the node attribute Node ID (and consequently node attributes Parent ID and Child ID) comprise unique node IDs generated in accordance with Expression (I) above. The node attribute Node Type ID comprise the exemplary Node Type IDs set out in Table A above. The node attributes Inward Connection Point ID and Outward Connection Point ID correspond to the exemplarily defined localized node perimeter positions discussed in Table B above.

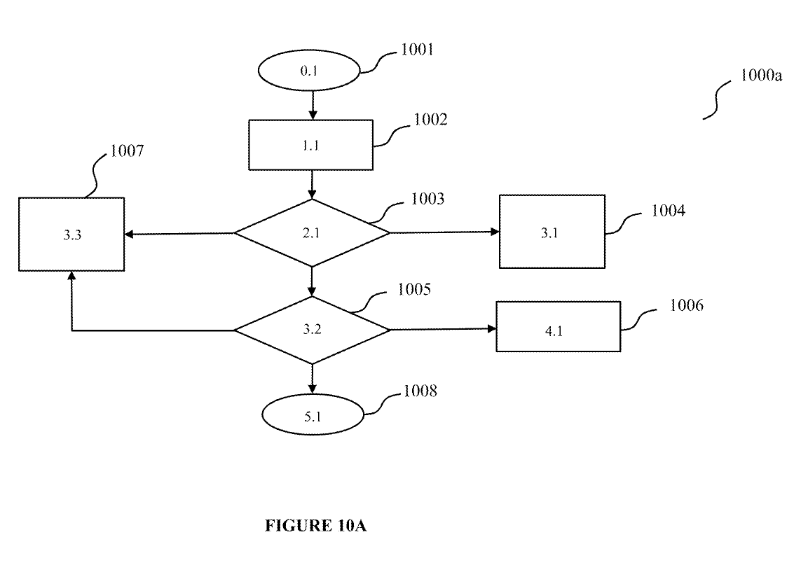

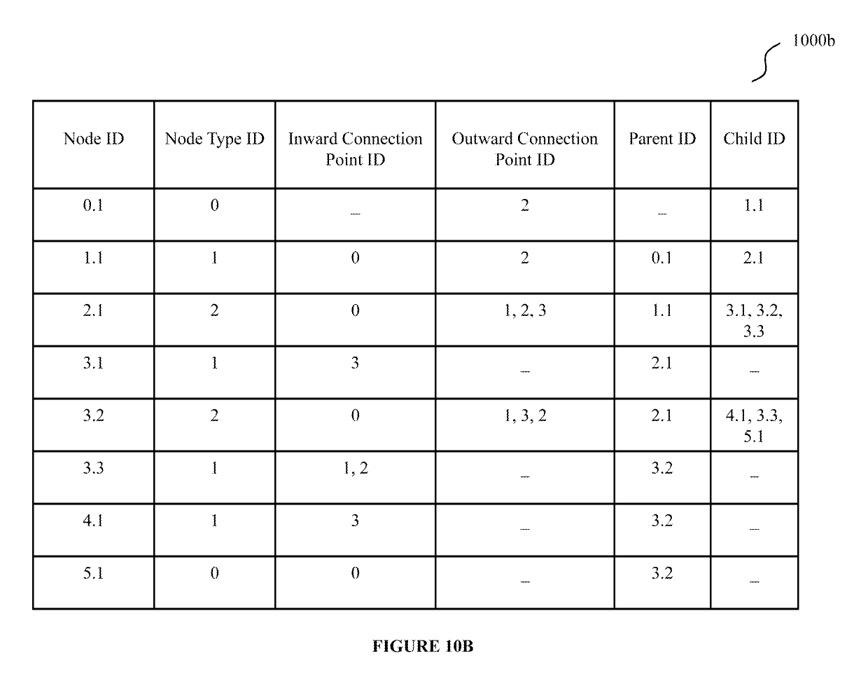

FIG. 10A provides an exemplary process flow structure 1000a comprising nodes 1001 to 1008. FIG. 10B illustrates a corresponding process flow record 1000b (which is based on the data structure template illustrated in FIG. 8) generated to represent process flow structure 1000a. As in the case of FIG. 10B, the node attribute Node ID (and consequently node attributes Parent ID and Child ID) comprise unique node IDs generated in accordance with Expression (I) above. The node attribute Node Type ID comprise the exemplary Node Type IDs set out in Table A above. The node attributes Inward Connection Point ID and Outward Connection Point ID correspond to the exemplarily defined localized node perimeter positions discussed in Table B above.

It would be noted from FIGS. 9B and 10B, that in instances where a node has multiple inward connection points, outward connection points, parent nodes or child nodes, the relevant data field corresponding to that node may include multiple data entries. In the illustrated embodiments the multiple data entries are separated by a delimiter. However, the skilled person would appreciate that any other method may be used to represent instances of a node having a plurality of inward connection points, outward connection points, parent nodes or child nodes.

A process flow record representing a process flow structure (such as a process flow record based on the data structure template illustrated in FIG. 8) may be populated by (i) parsing a process flow structure, (ii) creating within the corresponding process flow record, data records uniquely corresponding to each node of the process flow structure and (iii) populating data fields within to each data record, with data representing node attributes of the corresponding node.

In an embodiment of the invention, a process flow record corresponding to a process flow structure may be generated and populated concurrently with creation of the process flow structure. Responsive to addition of each node to the process flow structure, a corresponding data record is added to the process flow record and populated with data representing node attributes of said node.

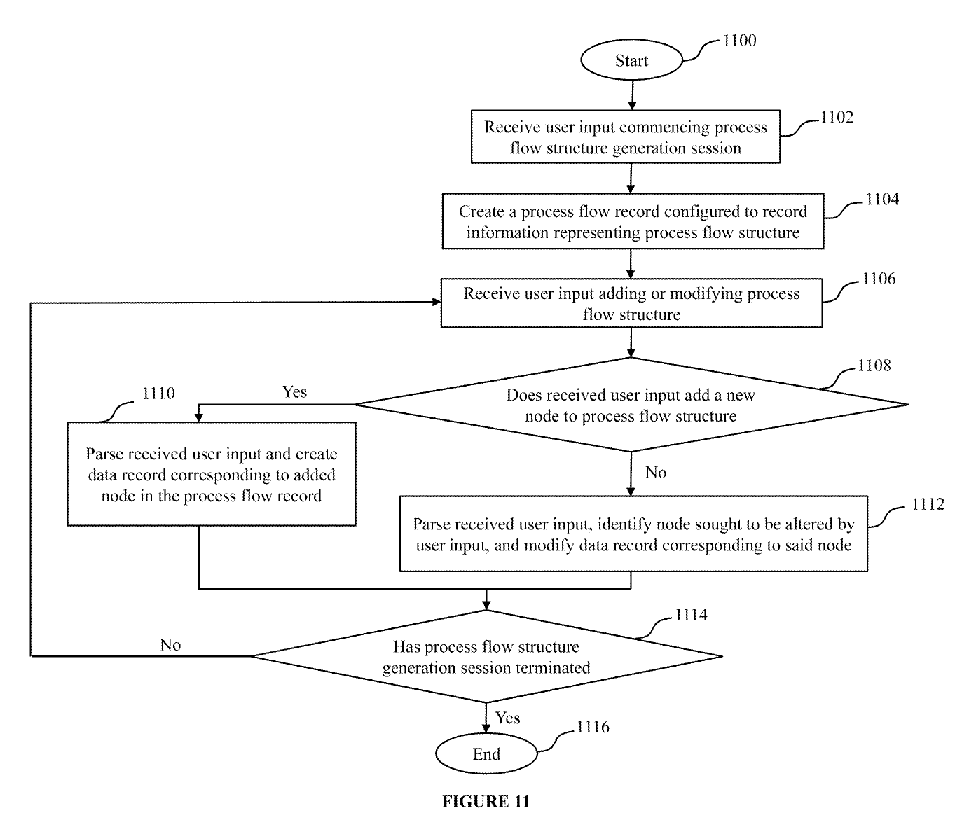

FIG. 11 illustrates an exemplary method embodiment wherein a process flow record is generated and populated concurrently with creation of a process flow structure. At step 1102, user input indicating commencement of a process flow structure generation session, is received. Step 1104 creates a process flow record configured to record information representing a process flow structure. At step 1106, user input directed to adding or modifying nodes of the process flow structure is received.

Step 1108 checks whether the received user input adds a new node to the process flow structure. If the received user input adds a new node to the process flow structure, step 1110 parses the received user input and creates a data record corresponding to the added node in the process flow record. Node attributes of the added node are recorded by adding appropriate data entries in corresponding data fields of the data record created for the added node. Alternatively, if the received user input for altering the process flow structure does not add a new record, it is understood to instead modify an existing record—in which case step 1113 parses the received user input, identifies the node under alteration, locates (from within the process flow record) the data record corresponding to the node under alteration and modifies said data record to reflect the effected changes in node attributes.

Step 1114 thereafter checks for whether the user has terminated the process flow structure generation session. If not, the method reverts to step 1106, else terminates at 1116.

The method of FIG. 11 describes a situation where a process flow record representative of a process flow structure are generated concurrent to generation of the process flow structure. It will however be understood that a process flow record representing an existing process flow structure may be generated and populated by parsing a previously created process flow structure and populating data records with information representing node attributes of each node of said previously created process flow structure. Similarly, modifications to a previously created process flow structure may be updated in a process flow record representing said process flow structure, by appropriately altering data fields within said process flow record.

It would also be understood that a process flow record representing a process flow structure may be parsed to re-generate and display the represented process flow structure on a visual display device. Re-generation would comprises parsing each data record within the process flow record, and generating a process flow structure having nodes and interconnections corresponding to the node attribute information stored in the parsed data records.

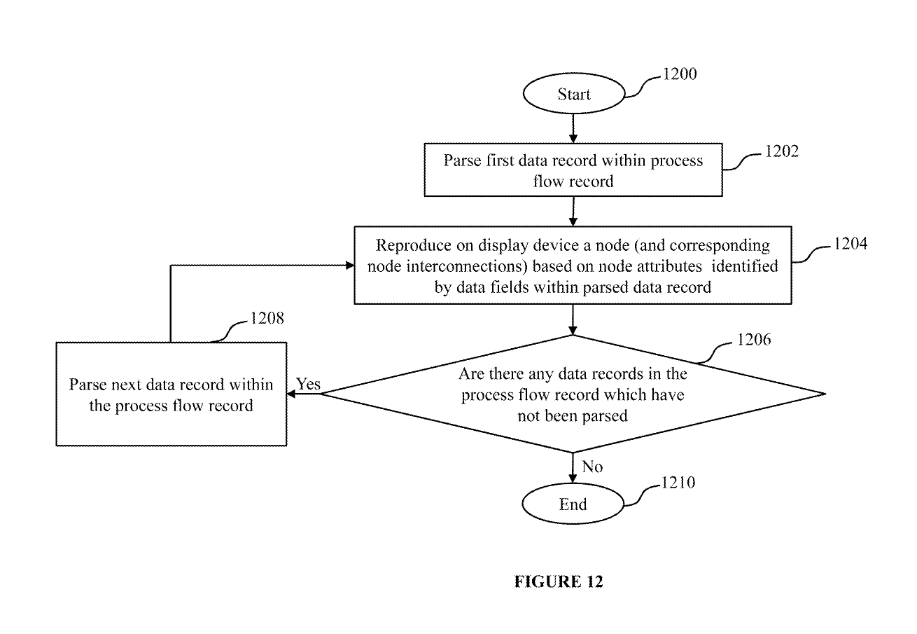

FIG. 12 illustrates a method where a populated process flow record having data fields represented in FIG. 8 may be used to re-generate the process flow structure corresponding to said process flow record.

Step 1202 parses a first data record within the process flow record. Based on node attribute values in data fields corresponding to the first data record, step 1204 generates a corresponding node with node interconnections, on a display device.

In an exemplary embodiment of the method, the process flow record is based on the data structure template of FIG. 8. In this embodiment, node attributes retrieved from the parsed data record and which are relevant to generation of a corresponding node and node interconnections on a display device may include one or more of the Node ID (which is necessary to uniquely identifying the node under consideration), Node Type ID (which identifies a node symbol to be displayed in association with the node), Parent ID (which identifies any interconnected parent nodes), Child ID (which identifies any interconnected child nodes), Inward Connection Point ID (identifying perimeter location of any incoming interconnections from parent nodes) and Outward Connection Point ID (identifying perimeter location of any outgoing interconnections to child nodes).

Step 1206 thereafter checks for any other data records within the process flow record which remain to be parsed. If one or more data records remain to be parsed, the method parses the next data record at step 1208 and reverts to step 1204, else terminates at step 1210.

Process flow records based on process flow structures created within the editor environment may be stored in a repository of process flow records.

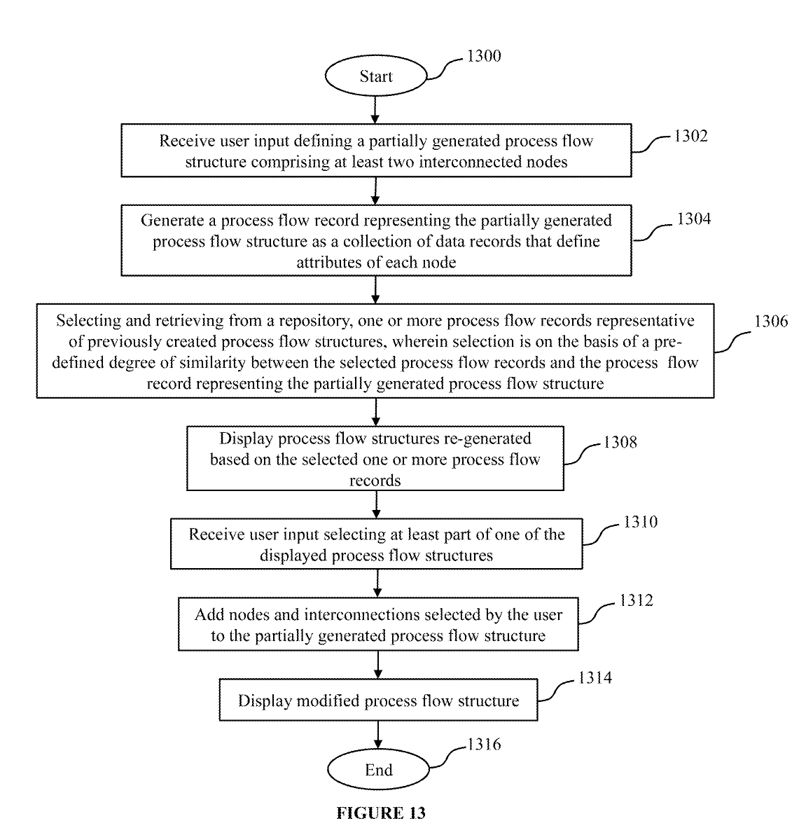

FIG. 13 illustrates an embodiment of the invention wherein the repository of process flow records enables a user to receive suggested structures for completing a partially generated process flow structure.

Step 1302 receives user input defining a partially generated process flow structure, which partially generated structure comprises at least two interconnected nodes. At step 1304 a process flow record is generated, representing the partially generated process flow structure as a collection of data records that define attributes of each node.

Step 1306 thereafter selects and retrieves from a repository, one or more process flow records that represent previously created process flow structures—said selection being based on ascertaining a pre-defined degree of similarity between the selected process flow records and the process flow record representing the partially generated process flow structure.

Step 1308 renders and displays process flow structures re-generated based on the selected process flow records. At step 1310, the method receives user input selecting at least part of one of the displayed process flow structures. Nodes and interconnections corresponding to the user selection are added to the partially generated process flow structure at step 1312. Step 1314 displays the modified process flow structure.

In the event certain nodes or interconnections within a selected process flow structure are inconsistent or incompatible with the partially generated process flow structure, such inconsistent or incompatible nodes or interconnections may be discarded when adding the selected process flow structure (or part thereof) to the partially generated process flow structure.

The present invention may be configured to search through all previously created process flow structures within a repository for identifying structures having the necessary degree of similarity with a partially generated process flow structure. In a particular embodiment however, the invention searches through n process flow structures most recently generated or selected within the editor environment. In a yet more particular embodiment, n may be a user defined or administrator defined variable. Each user may have a corresponding user profile, created in or accessible from the editor environment, wherein the value of n may be defined.

In another embodiment, the editor environment may store user profile information corresponding to each individual user, which enables identification of process flow structures previously created or selected by an individual user. In this configuration, the editor environment may identify an individual user by virtue of personalized login information, and may search specifically through process flow structures previously created by said individual user for identifying structures having the necessary degree of similarity with a partially generated process flow structure created by said user.

As discussed above, the invention presents for user selection one or more previously created process flow structures that exhibit a pre-defined degree of similarity with the partially generated process flow structure.

In an embodiment of the invention, checking for a pre-defined degree of similarity may comprise checking whether a previously created process flow structure includes a sub-set of nodes and corresponding interconnections that are identical to the entire set of nodes and interconnections within the partially generated process flow structure. In another embodiment, checking for a pre-defined degree of similarity may comprise checking whether a previously created process flow structure includes a second sub-set of nodes and corresponding interconnections that are identical to a first sub-set of nodes and corresponding interconnections within the partially generated process flow structure.

In a further embodiment, checking for a pre-defined degree of similarity comprises checking whether a previously created flow structure includes a second sub-set of nodes and corresponding interconnections that are identical to a first sub-set of two interconnected nodes and within a partially generated process flow structure. In yet another embodiment, checking for a pre-defined degree of similarity comprises checking whether a previously created flow structure includes a second sub-set of nodes and corresponding interconnections that are identical to a first sub-set of two interconnected nodes within a partially generated process flow structure, wherein the first sub-set of nodes does noes not include a node representing commencement (i.e. a start node) of the partially generated process flow structure.

In another embodiment, checking for a pre-defined degree of similarity comprises checking whether a previously created flow structure includes a second sub-set of nodes and corresponding interconnections that are identical to a first sub-set of two interconnected nodes and their interconnection within a partially generated process flow structure, wherein one of the two nodes within the first sub-set is the most recently generated node within the partially generated process flow structure.

Determining whether a previously created process flow structure includes a second sub-set of nodes and corresponding interconnections that are identical to a first sub-set of nodes within a partially generated process flow structure, may include a comparison based on or more node attributes associated with nodes within the two process flow structures. The node attributes under comparison may include one or more of: node symbols associated with each node, parent node(s) associated with a node under consideration, and child(ren) node(s) associated with a node under consideration. In a particular embodiment, the node attributes under comparison may additionally include one or both of: perimeter location(s) of outgoing connections from a node, and perimeter location(s) of incoming connections to a node.

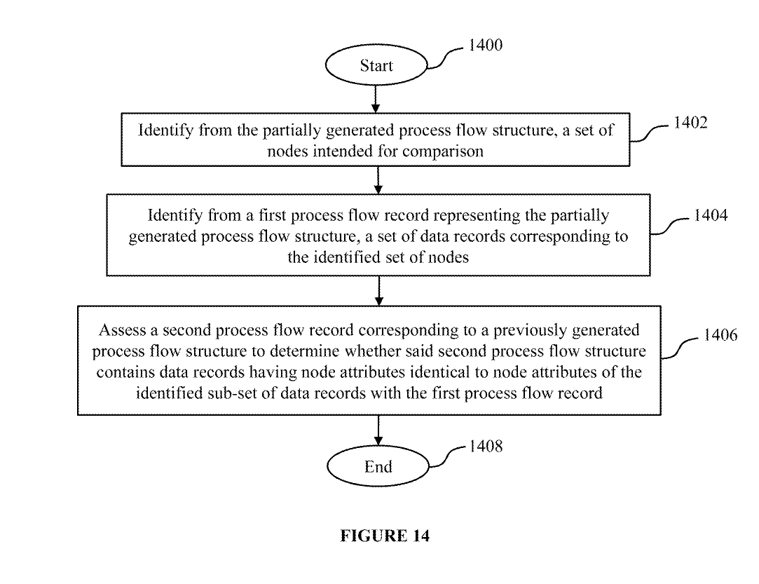

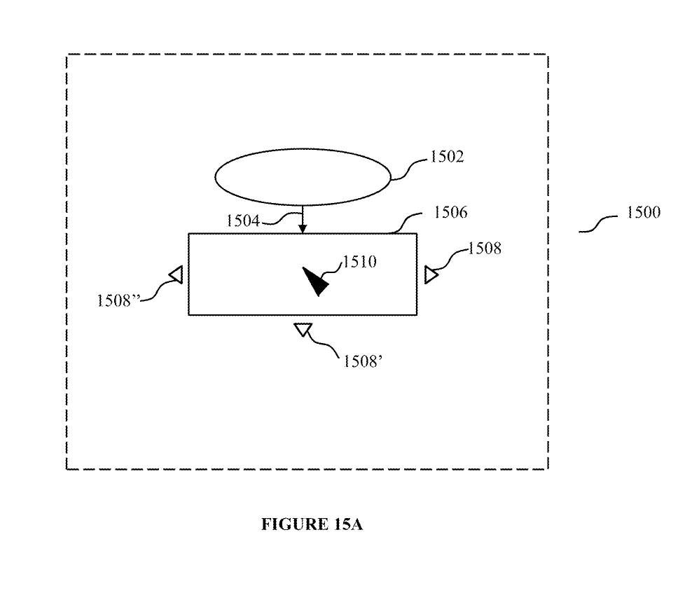

In an embodiment, comparing node attributes of a first sub-set of nodes (from within a partially generated process flow structure) with node attributes of nodes within a previously created process flow structure, may be achieved based on the method more generally described in connection with FIG. 13—i.e. by comparing a process flow record corresponding to the partially generated process flow structure with a process flow record corresponding to a previously created process flow structures retrieved from a repository. FIG. 14 discusses exemplary methods steps for achieving this comparison.

At step 1402, a set of nodes intended for comparison are identified within the partially generated process flow structure. Step 1404 identifies within a first process flow record representing the partially generated process flow structure, a set of data records which represent the identified set of nodes.

Thereafter, step 1406 assesses a second process flow record corresponding to a previously generated process flow structure, to determine whether said second process flow record contains data records having data field values (representing node attributes) identical to data field values (representing node attributes) of the identified set of data records within the first process flow record. If the second process flow record is found to contain data records having identical node attributes, it is determined that the previously created process flow structure satisfies a predefined degree of similarity in comparison with the partially generated process flow structure.

The various embodiments of the invention discussed above enable presentation of one or more suggested process flow structures on a display device, as selectable options for addition to a partially generated process flow structure.

In an embodiment, responsive to receiving user input identifying a node under consideration within a partially generated process flow structure, the invention displays suggested process flow structures that may be added at said node under consideration. The user may select one of the suggested process flow structures to be added at the node under consideration, or may alternatively choose an individual process node and/or connector from a default palette of individual nodes and connectors for addition at the node under consideration.

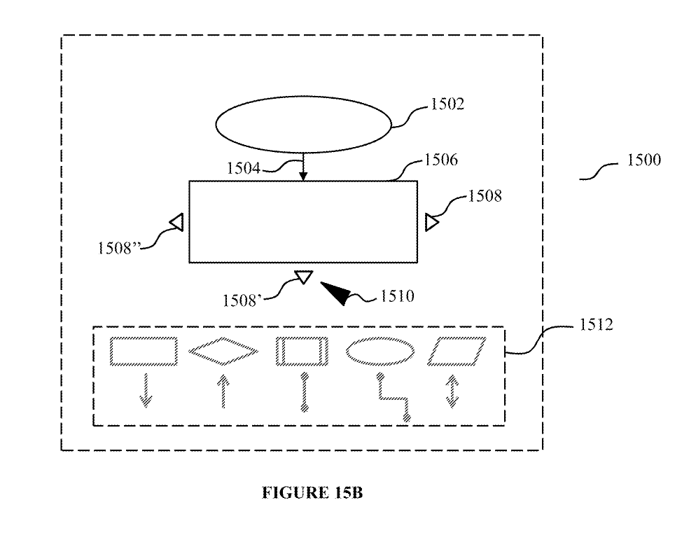

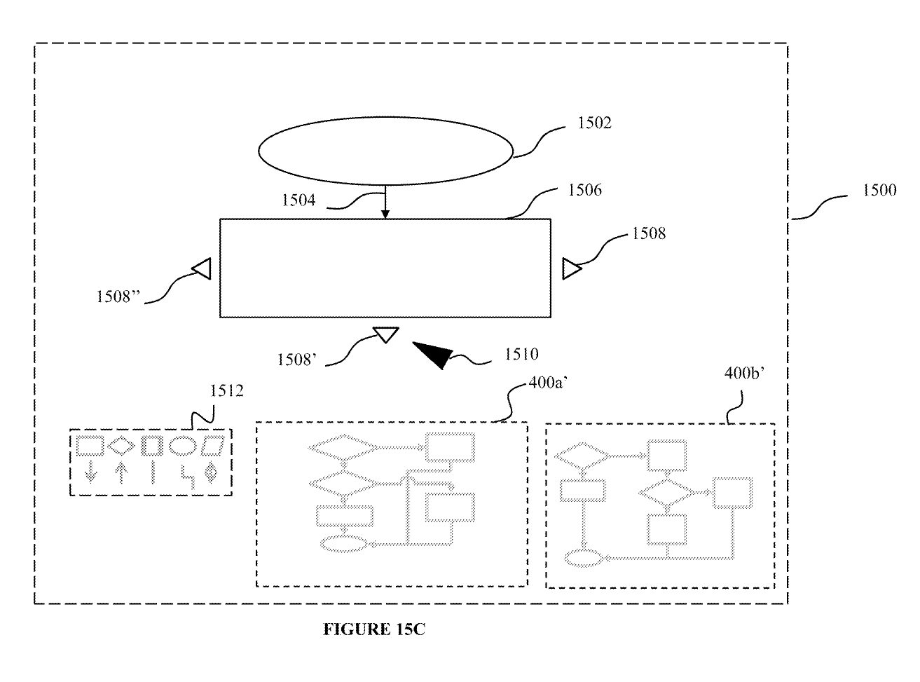

FIGS. 15A to 15C illustrate an exemplary editor environment for allowing a user to select from among available options for adding to a partially generated process flow structure.

FIG. 15A illustrates an exemplary editor environment 1500a, as presented to a user on a visual display device. The illustrated editor environment includes a partially generated process flow structure comprising a start node 1502, process node 1506 and a directed interconnection 1504 between the two nodes. Responsive to the user hovering the mouse/cursor over (or in the vicinity of) node 1506, said node is recognized as a node of interest or a node under consideration, whereupon the editor environment displays arrows 1508, 1508′ and 1508″ at each of unutilized connection points of said node. Thereafter, responsive to the user identifying a connection point of interest (for example by hovering the mouse/cursor over or in the vicinity of such connection point), the editor environment may display to the user one or more suggested process flow structures that may be added at said node under consideration, and in a preferred embodiment, specifically at the connection point of interest.

FIG. 15B illustrates an embodiment of the same editor environment, wherein responsive to the user identifying a connection point of interest 1508′ (for example by hovering the mouse/cursor 1510 over or in the vicinity such connection point 1508′), the editor environment displays to the user a default palette 1512 comprising individual nodes and connectors as potential options for addition at the node under consideration.

As illustrated in FIG. 15C, the editor environment may simultaneously present a user with the default palette as well as one or more suggested process flow structures as selectable alternatives for addition at the node under consideration.

In FIG. 15C, responsive to the user identifying a connection point of interest 1508′ (for example by hovering the mouse/cursor 1510 over or in the vicinity such connection point 1508′), the editor environment simultaneously displays to the user (i) a default palette 1512 comprising individual nodes and connectors as selectable options for addition at the node under consideration, (ii) a first process flow structure 400a′ as a selectable (or partially selectable) option for addition at the node under consideration and (iii) a second process flow structure 400b′ as a selectable (or partially selectable) option for addition at the node under consideration. It will be noted that in the illustrated exemplary embodiment of FIG. 15C, first process flow structure 400a′ and second process flow structure 400b′ correspond to the process flow structures respectively illustrated in FIGS. 4C and 4D as subsets of stored process flow structures 400a and 400b respectively, each of which (i) were found (in the method embodiments discussed in connection with FIGS. 4A to 4D) as having a sub-set of nodes and interconnections, that are identical to the arrangement of nodes and interconnections within the partially generated process flow structure, and (ii) which are therefore displayed to the user as selectable (or partially selectable) option s for addition at the node under consideration.

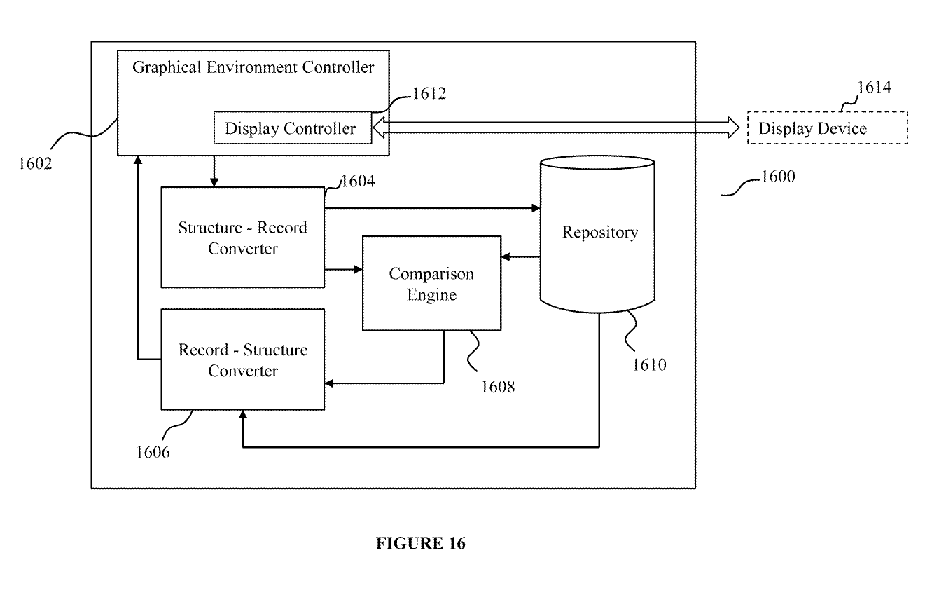

FIG. 16 illustrates an exemplary system 1600 of the invention, comprising graphical environment controller 1602, structure to record converter 1604, record to structure converter 1606, comparison engine 1608 and repository 1610.

Graphical environment controller 1602 is configured to control the editor environment presented to a user on a visual display device, including controlling input-output functions and rendering or displaying process flow structures on the visual display device. Comparison engine 1608 is configured to (i) receive information representing a partially generated process flow structure generated within the editor environment, and to identify previously created process flow structures having a predefined degree of similarity with said partially generated process flow structure. Repository 1610 comprises a database of information representing previously created process flow structures, and is configured to communicate such information to comparison engine 1608 to enable comparison with the partially generated process flow structure.

In the embodiment illustrated in FIG. 16, graphical environment controller 1602 includes display controller 1612. Display controller 1612 may be specifically configured to control visual display device 1614, for displaying process flow structures thereon. In the embodiment of FIG. 16, visual display device 1614 is external to system 1600. It would however be understood that the system of the present invention may include a visual display device.

In the embodiment of FIG. 16, system 1600 additionally comprises structure-record converter 1604. Convertor 1604 is configured to receive from graphical environment controller 1602, information regarding session activity within the editor environment including information describing a partially generated process flow structure. Converter 1604 is additionally configured to convert the partially generated process flow structure to a process flow record representing said process flow structure. In a particular embodiment of the invention, convertor 1604 may be configured to generate process flow records based on some or all of the data fields illustrated in data structure template 800.

The process flow record corresponding to the partially generated process flow structure is communicated to comparison engine 1608. Comparison engine 1608 retrieves from repository 1610, process flow records representing individual process flow structures previously created. In an embodiment of the invention, process flow records retrieved from repository 1610 include some or all of the data fields illustrated in data structure template 800. The process flow records retrieved from repository 1610 are compared against the process flow record corresponding to the partially generated process flow structure—to identify process flow records having a predefined degree of similarity. In an embodiment of the invention, comparison engine 1608 may compare process flow records based on the method(s) for comparison described above.

Process flow records that are identified by comparison engine 1608 as having the requisite degree of similarity are communicated to record-structure converter 1606. Converter 1606 is configured to receive process flow records identified as having the necessary degree of similarity, and to convert said flow records to information representing corresponding process flow structures. Said process flow structures may thereafter be communicated to graphical environment controller 1602, which graphically renders or displays said process flow structures on the visual display unit, as user selectable options for being added to a partially generated process flow structure. In the embodiment illustrated in FIG. 16, display of process flow structures on display device 1614 may be achieved through display controller 1612 provided within graphical environment controller 1602.

In an embodiment of the invention, repository 1610 is configured to store process flow structures generated by a user in the editor environment. In a particular embodiment, repository 1610 may be configured to store a finite number of process flow structures. It would be understood that the finite number of process flow structures may comprise any predefined number, and in an embodiment may be user or administrator defined. In one embodiment, repository 1610 may be configured to store n most recently created process flow structures.

In an embodiment of the invention, a process flow structure created within the editor environment may only be stored in repository 1610 upon completion of said process flow structure. Completion of a process flow structure may be determined in any number of ways, including (i) receiving from a user, input representing selection of a termination node (i.e. an end node), or (ii) receiving from a user, input representing an instruction to commit the process flow structure to non-transitory memory or to the repository 1610, or (iii) receiving from a user, input representing termination of a user session.

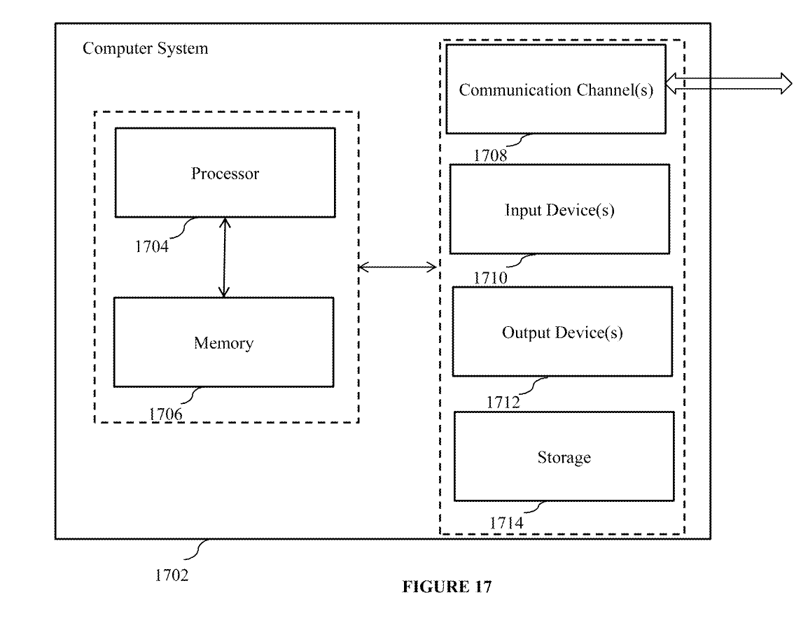

FIG. 17 illustrates an exemplary system in which various embodiments of the invention may be implemented.

The system 1702 comprises at-least one processor 1704 and at-least one memory 1706. The processor 1704 executes program instructions and may be a real processor. The processor 1704 may also be a virtual processor. The computer system 1702 is not intended to suggest any limitation as to scope of use or functionality of described embodiments. For example, the computer system 1702 may include, but not limited to, one or more of a general-purpose computer, a programmed microprocessor, a micro-controller, an integrated circuit, and other devices or arrangements of devices that are capable of implementing the steps that constitute the method of the present invention. In an embodiment of the present invention, the memory 1706 may store software for implementing various embodiments of the present invention. The computer system 1702 may have additional components. For example, the computer system 1702 includes one or more communication channels 1708, one or more input devices 1710, one or more output devices 1712, and storage 1714. An interconnection mechanism (not shown) such as a bus, controller, or network, interconnects the components of the computer system 1702. In various embodiments of the present invention, operating system software (not shown) provides an operating environment for various softwares executing in the computer system 1702, and manages different functionalities of the components of the computer system 1702.

The communication channel(s) 1708 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 1710 may include, but not limited to, a touch screen, a keyboard, mouse, pen, joystick, trackball, a voice device, a scanning device, or any another device that is capable of providing input to the computer system 1702. In an embodiment of the present invention, the input device(s) 1710 may be a sound card or similar device that accepts audio input in analog or digital form. The output device(s) 1712 may include, but not limited to, a user interface on CRT or LCD, printer, speaker, CD/DVD writer, or any other device that provides output from the computer system 1702.

The storage 1714 may include, but not limited to, magnetic disks, magnetic tapes, CD-ROMs, CD-RWs, DVDs, any types of computer memory, magnetic stipes, smart cards, printed barcodes or any other transitory or non-transitory medium which can be used to store information and can be accessed by the computer system 1702. In various embodiments of the present invention, the storage 1714 contains program instructions for implementing the described embodiments.

In an embodiment of the present invention, the computer system 1702 is part of a distributed network where various embodiments of the present invention are implemented for rapidly developing end-to-end software applications.

While not illustrated in FIG. 17, the system of FIG. 17 may further include some or all of the components of the system of the type more fully described in connection with FIG. 16 above.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1702. The method described herein is typically implemented as a computer program product, comprising a set of program instructions which is executed by the computer system 1702 or any other similar device. The set of program instructions may be a series of computer readable codes stored on a tangible medium, such as a computer readable storage medium (storage 1704), for example, diskette, CD-ROM, ROM, flash drives or hard disk, or transmittable to the computer system 1702, via a modem or other interface device, over either a tangible medium, including but not limited to optical or analogue communications channel(s) 1708. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for generating a process flow structure comprising a plurality of interconnected nodes, and configured to communicate with a process flow structure storage repository, the system comprising:
a processor;
a graphical environment controller configured to:
receive a first user input identifying a node within a first process flow structure; and
display on a display device, a selectable process flow structure for addition to the first process flow structure;
and
a comparison engine configured to:
compare the first process flow structure with previously stored process flow structures within the repository;
retrieve from among the previously stored process flow structures, a second process flow structure, wherein retrieval of the second process flow structure is based on identifying a predefined degree of similarity between the first process flow structure and the second process flow structure;
wherein the selectable process flow structure displayed by the graphical environment controller comprises a subset of the retrieved second process flow structure.

2. The system as claimed in claim 1, wherein:
the comparison engine is configured to retrieve a plurality of process flow structures from among the previously stored process flow structures, wherein retrieval of each process flow structure from the repository is based on identifying a predefined degree of similarity between the first process flow structure and said retrieved process flow structure; and
the graphical environment controller is configured to display a plurality of selectable process flow structures for addition to the first process flow structure, wherein each selectable process flow structure comprises a subset of one of the retrieved plurality of process flow structures.

3. The system as claimed in claim 1, wherein the graphical environment controller is configured to receive a second user input selecting a subset of the displayed selectable process flow structure for addition to the first process flow structure.

4. The system as claimed in claim 3, wherein the graphical environment controller is configured such that the subset of the displayed selectable process flow structure selected by the second user input comprises the entire displayed selectable process flow structure.

5. The system as claimed in claim 3, wherein the graphical environment controller is configured to display a combined process flow structure, wherein the combined process flow structure comprises the selected subset of the displayed selectable process flow structure added to the first process flow structure.

6. The system as claimed in claim 5, wherein the graphical environment controller is configured to add the selected subset of the displayed selectable process flow structure to the first process flow structure, at the node identified by the first user input.

7. The system as claimed in claim 1, wherein the comparison engine is configured to identify a predefined degree of similarity between the second process flow structure and the first process flow structure responsive to determining that the second process flow structure includes a second set of nodes and corresponding interconnections that are identical to a first set of nodes and corresponding interconnections within the first process flow structure.

8. The system as claimed in claim 7, wherein the comparison engine is configured such that determining that the second process flow structure includes a second set of nodes and corresponding interconnections that are identical to a first set of nodes and corresponding interconnections within the first process flow structure, comprises comparing node attributes respectively associated with nodes within the first set of nodes and the second set of nodes.

9. The system as claimed in claim 8, wherein the comparison engine is configured to compare node attributes including one or more of node symbols, parent nodes, associated child nodes, outgoing connections and incoming connections respectively associated with a corresponding node.

10. The system as claimed in claim 1, wherein the comparison engine is configured such that comparing the first process flow structure with previously stored process flow structures comprises comparing information representing the first process flow structure with information representing each previously stored process flow structure.

11. The system as claimed in claim 10, wherein;
the comparison engine is configured to retrieve:
information representing the first process flow structure, from a first process flow record corresponding to the first process flow structure; and
information representing a previously stored process flow structure, from a second process flow record corresponding to a previously stored process flow structure;
and wherein said first process flow record and said second process flow record are generated by a first convertor configured to convert process flow structures to process flow records.

12. The system as claimed in claim 10, wherein the first convertor is configured to generate process flow records comprising:
a set of data records, each data record representing a node within the corresponding process flow structure as a collection of associated node attributes; and
a set of data fields corresponding to each data record, wherein each data field within a data record represents a node attribute associated with the represented node.

13. The system as claimed in claim 12, wherein the comparison engine is configured such that comparing information representing the first process flow structure with information representing a previously stored process flow structure comprises:
comparing a first set of data records within the first process flow record with a second set of data records within the second process flow record.

14. The system as claimed in claim 13, wherein the comparison engine is configured such that comparing data records within the first process flow record with data records within the second process flow record comprises:
determining whether the second set of data records and the first set of data records have identical data field values.

15. The system as claimed in claim 14, comprising a second convertor configured to convert process flow records to process flow structures; and
wherein, responsive to a determination that the second set of data records and the first set of data records have identical data field values:
the comparison engine retrieves information corresponding to the second set of data records from the second process flow record;
the second convertor converts the retrieved information to a selectable process flow structure; and
the graphical environment controller graphically displays the selectable process flow structure on the display device.

16. A method for generating a process flow structure comprising a plurality of interconnected nodes, the method comprising the steps of:
receiving a first user input identifying a node within a first process flow structure;
retrieving from among previously stored process flow structures, a second process flow structure, wherein retrieval of the second process flow structure is based on identifying a predefined degree of similarity between the first process flow structure and the second process flow structure; and
displaying a selectable process flow structure for addition to the first process flow structure, the selectable process flow structure comprising a subset of the second process flow structure.

17. The method as claimed in claim 16, wherein:
the step of retrieving comprises retrieving a plurality of process flow structures from among the previously stored process flow structures, wherein retrieval of each process flow structure is based on identifying a predefined degree of similarity between the first process flow structure and said retrieved process flow structure; and
the step of displaying comprises displaying a plurality of selectable process flow structures for addition to the first process flow structure, wherein each selectable process flow structure comprises a subset of one of the retrieved plurality of process flow structures.

18. The method as claimed in claim 16, wherein the first process flow structure is a partially generated process flow structure.

19. The method as claimed in claim 16, wherein a subset of the displayed selectable process flow structure is selected by a second user input for addition to the first process flow structure.

20. The method as claimed in claim 19, wherein the selected subset comprises the entire displayed selectable process flow structure.

21. The method as claimed in claim 19, wherein the first process flow structure is modified by adding the selected subset of the displayed selectable process flow structure.

22. The method as claimed in claim 21, wherein the selected subset of the displayed selectable process flow structure is added to the first process flow structure at the node identified by the first user input.

23. The method as claimed in claim 16, wherein a predefined degree of similarity between the second process flow structure and the first process flow structure is identified responsive to determining that the second process flow structure includes a second set of nodes and corresponding interconnections that are identical to a first set of nodes and corresponding interconnections within the first process flow structure.

24. The method as claimed in claim 23, wherein determining that the second process flow structure includes a second set of nodes and corresponding interconnections that are identical to a first set of nodes and corresponding interconnections within the first process flow structure, comprises comparing node attributes respectively associated with nodes within the first set of nodes and the second set of nodes.

25. The method as claimed in claim 24, wherein the node attributes include one or more of node symbols, parent nodes, associated child nodes, outgoing connections and incoming connections respectively associated with a corresponding node.

26. The method as claimed in claim 16, wherein retrieving at least a second process flow structure from among previously stored process flow structures includes comparing information representing the first process flow structure with information representing each previously stored process flow structure.

27. The method as claimed in claim 26, wherein:
information representing the first process flow structure is retrieved from a first process flow record corresponding to the first process flow structure; and
information representing a previously stored process flow structure is retrieved from a second process flow record corresponding to a previously stored process flow structure.

28. The method as claimed in claim 26, wherein each process flow record comprises:
a set of data records, each data record representing a node within the corresponding process flow structure as a collection of associated node attributes; and
a set of data fields corresponding to each data record, wherein each data field within a data record represents a node attribute associated with the represented node.

29. The method as claimed in claim 28, wherein comparing information representing the first process flow structure with information representing a previously stored process flow structure comprises comparing a first set of data records within the first process flow record with a second set of data records within the second process flow record.

30. The method as claimed in claim 29, wherein comparing data records within the first process flow record with data records within the second process flow record comprises:
determining whether the second set of data records and the first set of data records have identical data field values.

31. The method as claimed in claim 30, comprising responding to a determination that the second set of data records and the first set of data records have identical data field values, with the steps of:
retrieving information corresponding to the second set of data records from the second process flow record; and
graphically rendering the selectable process flow structure on a display device, wherein the selectable process flow structure is rendered based on retrieved information corresponding to the second set of data records.

32. A computer program product for generating a process flow structure comprising a plurality of interconnected nodes, the computer program product comprising a non-transitory computer readable medium having computer readable program code embodied therein, the computer readable program code comprising instructions for:
receiving a first user input identifying a node within a first process flow structure;
retrieving from among previously stored process flow structures, a second process flow structure, wherein retrieval of the second process flow structure is based on identifying a predefined degree of similarity between the first process flow structure and the second process flow structure; and
displaying a selectable process flow structure for addition to the first process flow structure, the selectable process flow structure comprising a subset of the second process flow structure.
